(19) United States
(12) Patent Application Publication
(10) Pub. No.: US 2024/0128657 A1
(43) Pub. Date: Apr. 18, 2024

(54) ANTENNA ARRAY

(71) Applicant: Rohde & Schwarz GmbH & Co. KG, Munich (DE)

(72) Inventor: Raimon GOERITZ, Berlin (DE)

(21) Appl. No.: 18/370,226

(22) Filed: Sep. 19, 2023

(30) Foreign Application Priority Data
Oct. 17, 2022 (EP) 22 201 792.3

(51) Int. Cl. H01Q 21/12; H01Q 3/24

(52) U.S. Cl. CPC H01Q 21/12; H01Q 3/242

(57) ABSTRACT

An antenna array (10) is provided. Said antenna array (10) comprises a main plane comprising multiple antenna elements (11, 12, 13, 14, 15, 16, 17), and at least one further plane being substantially parallel to the main plane. In this context, each of at least one subset (11, 13, 15, 17) of the multiple antenna elements (11, 12, 13, 14, 15, 16, 17) is adapted such that at least one outer portion of each antenna element of said at least one subset (11, 13, 15, 17) is continued in at least one of the least one further plane.

This patent application claims priority to European Patent Application No. 22 201 793.4, “Antenna Array,” filed Oct. 17, 2022, the contents of which are incorporated herein by reference in their entirety.

The invention relates to an antenna array especially for ultra wide band radio frequency communication between different radio participants.

Generally, in times of an increasing number of communication applications providing wireless connectivity capabilities, there is a growing need of an antenna array for ultra wide band radio frequency communication between different radio participants in order to ensure a highly flexible and efficient communication.

US 2003/0142035 A1 relates to a phased array antenna including a substrate and a plurality of spaced apart phased array antenna elements carried by the substrate and arranged along an imaginary Archimedean spiral. More particularly, the imaginary Archimedean spiral includes a plurality of levels, and a spacing between adjacent pairs of phased array antenna elements along the imaginary Archimedean spiral is substantially equal to a radial spacing between adjacent levels.

Furthermore, US 2011/0133986 A1 discloses a directional multiple-polarization wide band antenna array working in a selected frequency band and including a plurality of N individual sensors of convoluted spiral type complementing a number of strands arranged according to a structure making it possible to obtain for obtaining a given azimuth coverage, each of the N sensors including a reflecting plane attached to the antenna by an insulating spacer E, matching cells suited to the working frequency band of said array, and separate output channels and for the vertically-polarized signals and for the horizontally-polarized signals.

Disadvantageously, especially due to the respective spacing between the antennas, such antenna arrays are limited to a bandwidth of about an octave.

Accordingly, there is the object to provide an antenna array allowing for going significantly beyond a bandwidth of one octave, thereby ensuring a high flexibility and efficiency of wireless communication.

This object is solved by the features of claim 1 for an antenna array. The dependent claims contain further developments.

According to the invention, an antenna array is provided. Said antenna array comprises a main plane comprising multiple antenna elements, and at least one further plane being substantially parallel to the main plane. In this context, each of at least one subset of the multiple antenna elements is adapted such that at least one outer portion of each antenna element of said at least one subset is continued in at least one of the least one further plane. Advantageously, this does not only allow for going significantly beyond a bandwidth of one octave but also ensures a high flexibility and efficiency of wireless communication.

According to a first preferred implementation form of the invention, a subset or each of the multiple antenna elements comprises or is a sinuous antenna. Advantageously, for instance, bandwidth can further be increased.

According to a second preferred implementation form of the invention, the at least one outer portion comprises or is at least one outer arm or all outer arms of the sinuous antenna. Advantageously, for example, complexity can be reduced, thereby increasing efficiency.

According to a further preferred implementation form of the invention, the multiple antenna elements are arranged in an uniform or a non-uniform manner. Advantageously, for instance, with special respect to the arrangement of the multiple antenna elements, a particularly high flexibility can be ensured, thereby increasing the number of possible applications of the invention.

According to a further preferred implementation form of the invention, the antenna array comprises or is an active electronical scanned array. Advantageously, for example, this efficiently allows for beamforming.

According to a further preferred implementation form of the invention, the antenna array comprises a bandwidth of at least two octaves. Advantageously, for instance, the main plane can be used for a bandwidth of 20 GHz to 40 GHz, whereas at least one of the at least one further plane can be used for a bandwidth of 10 GHz to 20 GHz. Further advantageously, the at least one further plane allows for increasing the usable frequency range downwards.

According to a further preferred implementation form of the invention, the at least one outer portion comprises a toothlike or wavelike shape. Advantageously, for example, the radio frequency characteristics each antenna element of the at least one subset can be adjusted in a flexible and efficient manner.

According to a further preferred implementation form of the invention, the multiple antenna elements are arranged such that neighboring ones of the multiple antenna elements comprise a certain distance with respect to each other. Advantageously, for instance, the multiple antenna elements can be arranged in an equidistant manner, thereby reducing complexity, and thus also inefficiencies.

According to a further preferred implementation form of the invention, the certain distance is equal to between 0.45 times and 0.95 times, preferably between 0.48 times and 0.9 times, more preferably between 0.49 times and 0.7 times, most preferably between 0.5 times and 0.6 times, of the corresponding operational wavelength. Advantageously, for example, efficiency can further be increased.

According to a further preferred implementation form of the invention, the at least one subset is adapted such that each antenna element of said at least one subset is equivalent to every fifth antenna element of the multiple antenna elements. Advantageously, for instance, every sixth, seventh, eight, ninth, tenth, or any higher order antenna element can analogously be used, thereby ensuring a particularly high flexibility.

According to a further preferred implementation form of the invention, the at least one subset is adapted such that each antenna element of said at least one subset is equivalent to every fourth antenna element of the multiple antenna elements. Advantageously, for example, an increase of the usable frequency range downwards can be adjusted in an efficient and flexible manner.

According to a further preferred implementation form of the invention, the at least one subset is adapted such that each antenna element of said at least one subset is equivalent to every third antenna element of the multiple antenna elements. Advantageously, for instance, a stable far-field behavior of the antenna array can be ensured. In this context, further advantageously, it is noted that on the one hand, a slightly lower gain at lower frequencies is caused by a decreasing number of antenna elements at the lower frequencies, and on the other hand, this is inventively counteracted because the attenuation of the free space wave is lower at low frequencies and compensates the effect by more than half within this frequency band, exemplarily between 5 GHz and 50 GHz, and potential power amplifiers behind the antenna array have more gain at lower frequencies and can also be used for compensation.

According to a further preferred implementation form of the invention, the at least one subset is adapted such that each antenna element of said at least one subset is equivalent to every second antenna element of the multiple antenna elements. Advantageously, for example, complexity can be reduced, thereby increasing efficiency.

According to a further preferred implementation form of the invention, the at least one outer portion of each antenna element of the at least one subset is continued with the aid of at least one respective extension being galvanically or capacitively coupled to the at least one outer portion. Advantageously, for instance, the radio frequency characteristics of the antenna array can be adjusted in a flexible and efficient manner.

According to a further preferred implementation form of the invention, a galvanic coupling of the at least one respective extension to the at least one outer portion of each antenna element of the at least one subset comprises at least one pin-like connection. Advantageously, for example, said galvanic coupling can easily be achieved in a reliable manner.

Exemplary embodiments of the invention are now further explained with respect to the drawings by way of example only, and not for limitation. In the drawings:

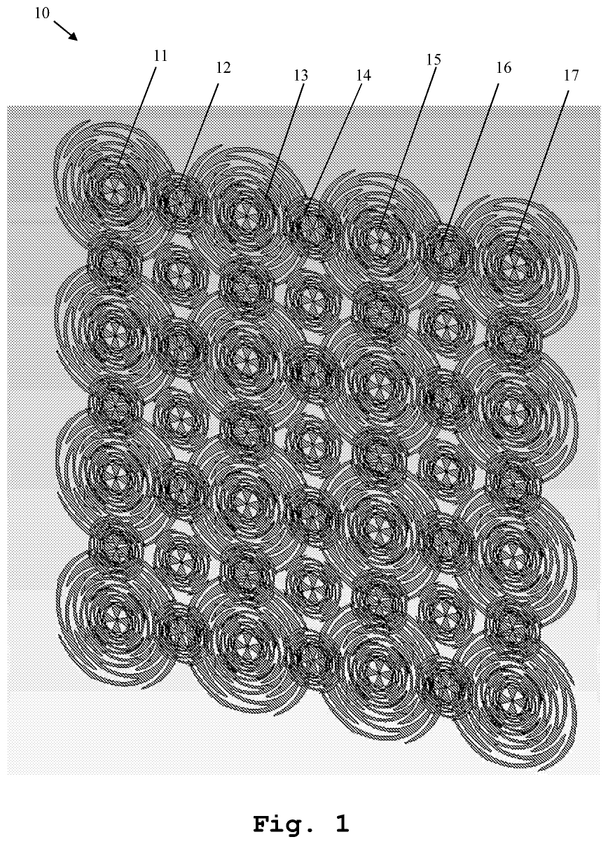

FIG. 1 shows an exemplary embodiment of an inventive antenna array;

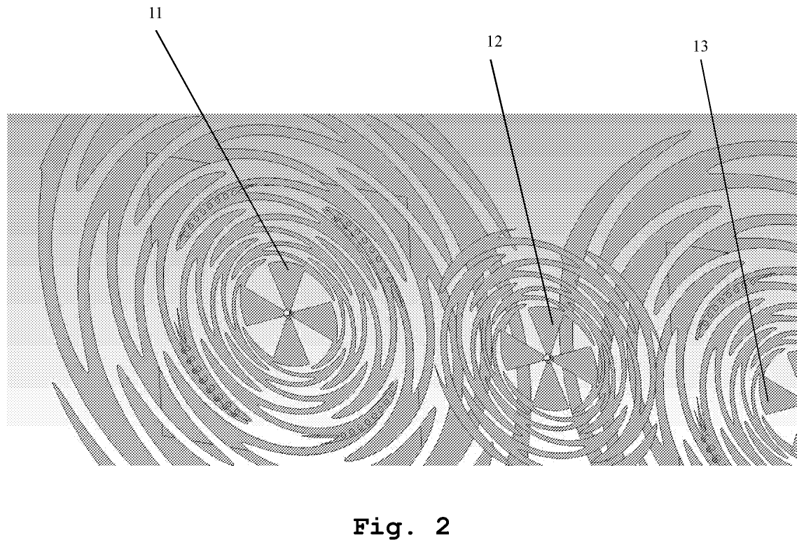

FIG. 2 shows a detail view of the antenna array according to FIG. 1;

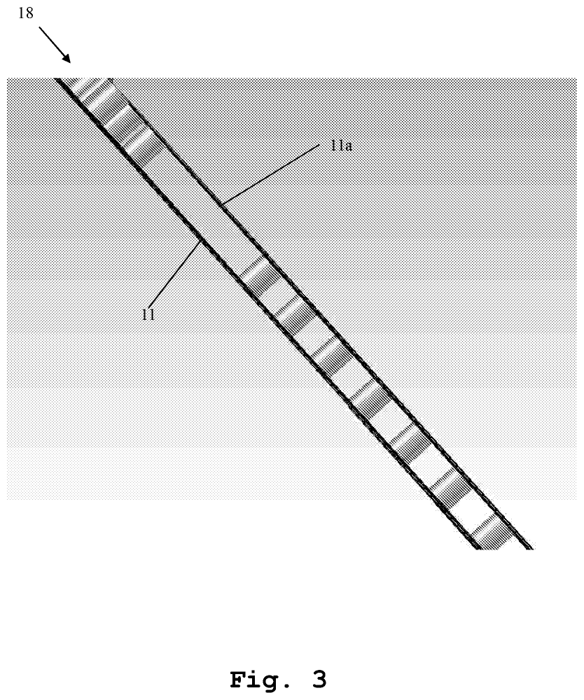

FIG. 3 shows a further detail view of the antenna array of FIG. 1;

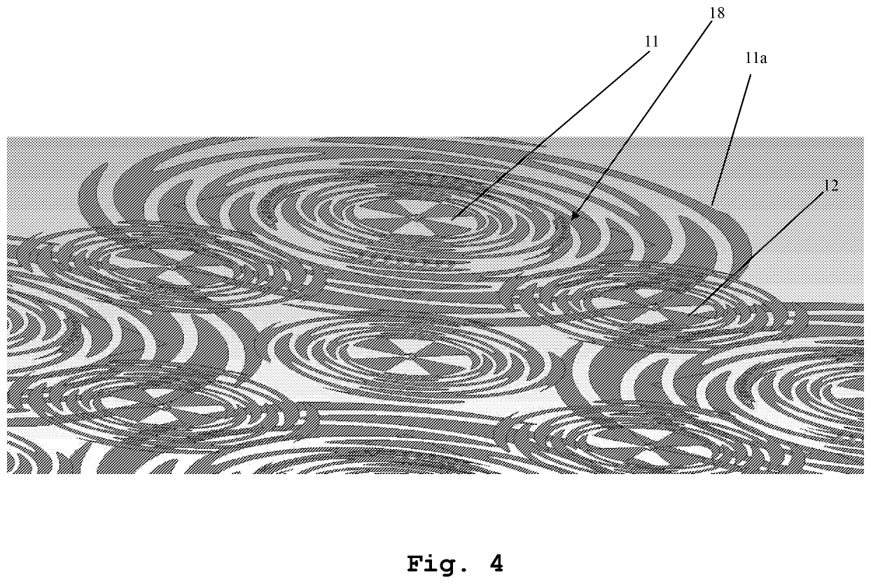

FIG. 4 shows a further detail view of the antenna array according to FIG. 1;

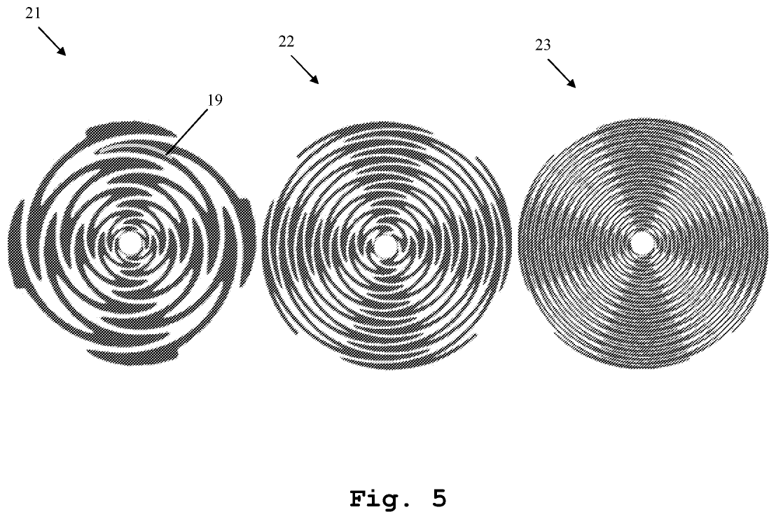

FIG. 5 illustrates three exemplary embodiments of a sinuous antenna in the context of the invention; and

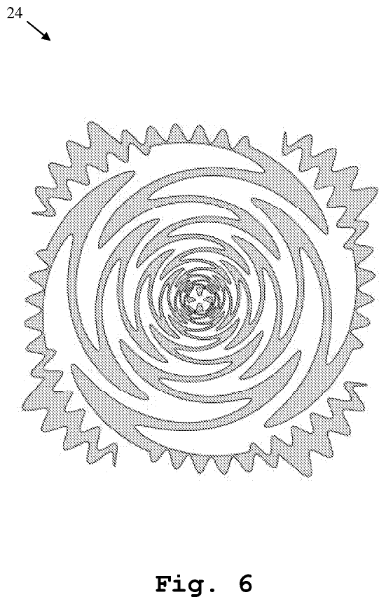

FIG. 6 depicts a further exemplary embodiment of a sinuous antenna in the context of the invention.

Firstly, FIG. 1 shows an exemplary antenna array 10 in the sense of the invention.

Said antenna array 10 comprises multiple antenna elements, of which seven are exemplarily equipped with reference signs 11, 12, 13, 14, 15, 16, and 17.

It is noted that the antenna array comprises a certain number of rows and a certain number of columns. Preferably, said certain number of rows may be equal to said certain number of columns. In this exemplary case, both numbers are equal to seven. In this context, it is further noted that the above-mentioned antenna elements 11, 12, 13, 14, 15, 16, 17, which are mentioned representatively for all of the multiple antenna elements of the antenna array 10, are comprised by the first row of the antenna array 10.

As it can further be seen from FIG. 1, the antenna array 10 comprises a main plane comprising the multiple antenna elements.

In addition to this, the antenna array 10 comprises a further plane being substantially parallel to the main plane, wherein each of a subset of the multiple antenna elements is adapted such that at least one outer portion of each antenna element of said subset is continued in the further plane. Exemplarily, said subset comprises the above-mentioned antenna elements 11, 13, 15, and 17.

With respect to the term “substantially parallel”, it is noted that said wording can especially be understood in a manner that a normal of the main plane and the further plane enclose an angle between 80 degrees and 100 degrees, preferably between 85 degrees and 95 degrees, more preferably between 88 degrees and 92 degrees, most preferably between 89.5 degrees and 90.5 degrees.

Furthermore, in accordance with FIG. 1, each of the multiple antenna elements is a sinuous antenna.

Said sinuous antenna can especially be a combination of a spiral antenna and a log-periodic antenna. Preferably, such a sinuous antenna comprises four arms. With respect to said four arms, it might be particularly advantageous if each of said four arms is shifted and placed about 90 degrees away from each other.

With respect to the term “about 90 degrees”, it is noted that said wording can especially be understood in a manner that the respective angle does not deviate more than 5 degrees, preferably 3 degrees, more preferably 1 degree, most preferably 0.5 degrees, from 90 degrees.

Again, with respect to the four arms of the sinuous antenna, it is noted that a strip line or microstrip balun can be used as a feed line to each of the four arms.

It is further noted that it might be particularly advantageous if any two opposite arms are physically separated by a length equal to about the half of the corresponding operational wavelength.

With respect to the term “about the half of the corresponding operational wavelength”, it is noted that said wording can especially be understood in a manner that the respective length does not deviate more than 10 percent, preferably 5 percent, more preferably 3 percent, most preferably 1 percent, from the half of the corresponding operational wavelength.

Now, with respect to the above-mentioned at least one outer portion of each antenna element of the subset, which is continued in the further plane, it is noted that as it can be seen from FIG. 1, the at least one outer portion can exemplarily be seen as the above-mentioned four arms of the sinuous antenna or of each of the sinuous antennas, respectively.

As it can further be seen from FIG. 1, the multiple antenna elements of the antenna array 10 are exemplarily arranged in an uniform manner. Alternatively, it is noted that the multiple antenna elements could be arranged in a non-uniform manner.

It is further noted that the antenna array 10 can especially be an active electronical scanned array.

Moreover, it should be mentioned that the antenna array 10 may comprise a bandwidth of at least two octaves. In this context, the main plane may be used for a bandwidth of 20 GHz to 40 GHz, whereas the further plane may be used for a bandwidth of 10 GHz to 20 GHz. Advantageously, the further plane allows for increasing the usable frequency range downwards.

Further advantageously, a stable far-field behavior of the antenna array 10 can be ensured. In this context, it is noted that on the one hand, a slightly lower gain at lower frequencies is caused by a decreasing number of antenna elements at the lower frequencies, and on the other hand, this is inventively counteracted because the attenuation of the free space wave is lower at low frequencies and compensates the effect by more than half within this frequency band, exemplarily between 5 GHz and 50 GHz, and potential power amplifiers behind the antenna array 10 have more gain at lower frequencies and can also be used for compensation.

As it can further be seen from FIG. 1, the multiple antenna elements are arranged such that neighboring ones of the multiple antenna elements, such as the antenna elements 11 and 12, the antenna elements 12 and 13, the antenna elements 13 and 14, the antenna elements 14 and 15, the antenna elements 15 and 16, and the antenna elements 16 and 17, comprise a certain distance with respect to each other.

In this context, said certain distance may be equal to about the half of the corresponding operational wavelength.

It is further noted that the above-mentioned subset is adapted such that each antenna element of said subset is equivalent to every second antenna element, such as the antenna elements 11, 13, 15, 17, of the multiple antenna elements.

Furthermore, it is noted that the above-mentioned at least one outer portion of each antenna element of the subset or each of the respective four arms of each sinuous antenna to be continued, respectively, is continued with the aid of at least one respective extension or four respective arm extensions, respectively, being galvanically or capacitively coupled to the at least one outer portion or each of the respective four arms of each sinuous antenna to be continued, respectively.

Now, with respect to FIGS. 2 and 3, it is noted that said FIG. 2 illustrates a detail view of the antenna array 10 of FIG. 1, in particular a magnification of the above-mentioned antenna elements 11, 12, 13 of the antenna array 10, whereas said FIG. 3 shows a magnification of the above-mentioned antenna element 11 in order to illustrate the above-mentioned at least one respective extension, exemplarily the arm extension 11a, and the galvanic coupling in the exemplary form of multiple pin-like connections 18.

In addition to this, it is noted that FIG. 4 showing a further detail view of the antenna array 10 according to FIG. 1 substantially combines said FIG. 2 and FIG. 3.

With respect to the multiple pin-like connections 18, it should be mentioned that each of said multiple pin-like connections 18 may preferably be of a cylindrical shape.

In addition to this or as an alternative, each of said multiple pin-like connections 18 may especially be substantially perpendicular to the at least one outer portion or at least one of the four arms of the sinuous antenna, respectively, and/or to the at least one respective extension or at least one of the four respective arm extensions, respectively.

Further, with respect to the term “substantially perpendicular”, it is noted that said wording can especially be understood in a manner that the respective angle does not deviate more than 5 degrees, preferably 3 degrees, more preferably 1 degree, most preferably 0.5 degrees, from 90 degrees.

With respect to the above-mentioned at least one outer portion of each antenna element of the subset or each of the respective four arms of each sinuous antenna to be continued, respectively, the above-mentioned at least one respective extension or the four respective arm extensions, respectively, and each of the above-mentioned pin-like connections, it is noted that at least a subset, preferably each, of said parts can be made of an electrically conductive material.

Whereas a sinuous antenna in the sense of the invention has substantially been described above in the context of FIG. 1, FIG. 5 illustrates three exemplary embodiments 21, 22, 23 of a sinuous antenna in the sense of the invention.

In the light of said FIG. 5, it is noted that each of the four arms of a sinuous antenna comprises an angular width, which is exemplarily marked with respect to the sinuous antenna 21 and equipped with reference sign 19. Said angular width especially increases with the distance from the center of the sinuous antenna preferably in a continuous manner.

It is further noted that with the aid of said angular width, the corresponding impedance of the sinuous antenna can exemplarily be adjusted.

Moreover, it should be mentioned that according to FIG. 5, the above-mentioned at least one outer portion or the four arms of the sinuous antenna, respectively, may comprise an arrowy shape.

In this context, it can also be seen from FIG. 5 that said arrowy shape of the sinuous antenna 23 is sharper than the arrowy shape of the sinuous antenna 22, whereas the arrowy shape of the sinuous antenna 22 is sharper than the arrowy shape the sinuous antenna 21.

Additionally, it is noted that the angular width of the sinuous antenna 23 within an area being maximally distant from the center of said sinuous antenna 23 is the highest one in comparison with the sinuous antennas 22 and 21.

Further additionally, it is noted that the angular width of the sinuous antenna 21 within an area being maximally distant from the center of said sinuous antenna 21 is the smallest one in comparison with the sinuous antennas 22 and 23.

Finally, it should be mentioned that in accordance with FIG. 6 illustrating a further exemplary embodiment 24 of a sinuous antenna in the sense of the invention, the above-mentioned at least one outer portion or the four arms of the sinuous antenna, respectively, may comprise a toothlike or wavelike shape.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

1. An antenna array comprising:
a main plane comprising multiple antenna elements and
at least one further plane being substantially parallel to the main plane,
wherein each of at least one subset of the multiple antenna elements is adapted such that at least one outer portion of each antenna element of said at least one subset is continued in at least one of the least one further plane.

2. The antenna array according to claim 1,
wherein a subset or each of the multiple antenna elements comprises or is a sinuous antenna.

3. The antenna array according to claim 2,
wherein the at least one outer portion comprises or is at least one outer arm or all outer arms of the sinuous antenna.

4. The antenna array according to claim 1,
wherein the multiple antenna elements are arranged in an uniform or a non-uniform manner.

5. The antenna array according to claim 1,
wherein the antenna array comprises or is an active electronical scanned array.

6. The antenna array according to claim 1,
wherein the antenna array comprises a bandwidth of at least two octaves.

7. The antenna array according to claim 1,
wherein the at least one outer portion comprises a toothlike or wavelike shape.

8. The antenna array according to claim 1,
wherein the multiple antenna elements are arranged such that neighboring ones of the multiple antenna elements comprise a certain distance with respect to each other.

9. The antenna array according to claim 8,
wherein the certain distance is equal to between 0.45 times and 0.95 times, preferably between 0.48 times and 0.9 times, more preferably between 0.49 times and 0.7 times, most preferably between 0.5 times and 0.6 times, of the corresponding operational wavelength.

10. The antenna array according to claim 1,
wherein the at least one subset is adapted such that each antenna element of said at least one subset is equivalent to every fifth antenna element of the multiple antenna elements.

11. The antenna array according to claim 1,
wherein the at least one subset is adapted such that each antenna element of said at least one subset is equivalent to every fourth antenna element of the multiple antenna elements.

12. The antenna array according to claim 1,
wherein the at least one subset is adapted such that each antenna element of said at least one subset is equivalent to every third antenna element of the multiple antenna elements.

13. The antenna array according to claim 1,
wherein the at least one subset is adapted such that each antenna element of said at least one subset is equivalent to every second antenna element of the multiple antenna elements.

14. The antenna array according to claim 1,
wherein the at least one outer portion of each antenna element of the at least one subset is continued with the aid of at least one respective extension being galvanically or capacitively coupled to the at least one outer portion.

15. The antenna array according to claim 14,
wherein a galvanic coupling of the at least one respective extension to the at least one outer portion of each antenna element of the at least one subset comprises at least one pin-like connection.
